(19) United States
(12) Patent Application Publication
(10) Pub. No.: US 2026/0012344 A1
(43) Pub. Date: Jan. 8, 2026

(54) DEVICES AND METHODS FOR PROVIDING SECURED COMMUNICATIONS

(71) Applicant: Emprise Corporation, Ledyard, CT (US)

(72) Inventors: James Joseph Diaz, Gales Ferry, CT (US); John Delbert Squires, Virginia Beach, VA (US); Benjamin Quentin Stanley, Whitehall, OH (US); Barry Alexander Taylor, Suffolk, VA (US); Erik Raffaele Ostrander, Naugatuck, CT (US); Evan Courtney, Norwich, CT (US)

(21) Appl. No.: 19/259,093

(22) Filed: Jul. 3, 2025

Related U.S. Application Data
(60) Provisional application No. 63/668,014, filed on Jul. 5, 2024.

(51) Int. Cl. H04L 9/14; H04L 9/08

(52) U.S. Cl. CPC H04L 9/14; H04L 9/0819

(57) ABSTRACT

The present disclosure provides systems and methods for transferring secure data and may be particularly useful for allowing secure communication between ship inspection program (SIP) tablets and a SAMM database via the ship's internal network. A docking device for transferring data comprises a housing, a connector for coupling the housing to an external device and a processor comprising a computer-readable storage device storing program instructions. The program instructions, when executed by the processor: authenticate the external device, receive data encrypted from the external device, decrypt the data, re-encrypt the data and transmit the data to an external network.

### CROSS-REFERENCE TO RELATED APPLICATIONS

This application claims the benefit of U.S. Provisional Application Ser. No. 63/668,014, filed Jul. 5, 2024, the complete disclosure of which is incorporated herein by reference for all purposes.

### TECHNICAL FIELD

This description generally relates to devices and methods for transferring secure data from one or more external devices to an internal network

### BACKGROUND

The normal operation of a marine vessel depends on the availability of machinery on board, and regular maintenance is necessary to ensure that the vessel is always in good condition. Traditional ship maintenance of the rotating equipment is based on regular openings onboard or in a shipyard, which requires dismantling, transportation, and professional inspection. Thus, ships need to go out of business until the maintenance is completed. The workload is large and time-consuming, which increases the pressure on the shipping company. However, predictive maintenance programs can transform maintenance from reactive to proactive, preventing potential failures with early problem detection, increasing equipment lifespan and shortening maintenance windows.

Shipping is increasingly relying on digital solutions for the completion of everyday tasks. For example, Ship Inspection Program (SIP) tablets are mobile devices that allow operators to more accurately collect data related to a vessel's structural condition, operating systems, equipment, certificates and documents, navigation safety, emergency systems, crew procedural compliance and other critical functions of a marine vessel. These tablets have streamlined the inspection process by reducing the reliance on paper documents that can cause clerical overload, procedural compliance mistakes and lack of real-time monitoring. In addition, these tablets allow maintenance programs to become more proactive as the inspection process may identify potential issues with systems or equipment before they fail.

The increase in digital solutions on marine vessels, however, has increased cyber vulnerabilities and risks. For example, to reduce these risks and vulnerabilities, certain marine vessels, such as U.S. Coast Guard and Navy vessels, have strict security requirements that disallow the use of standard wireless operating protocols, such as Wi-Fi, Bluetooth, Zigbee and the like. In addition, these security requirements do not allow tablets to be plugged directly into the vessel's local network with standard connectors, such as USB, Ethernet dongles and the like.

Thus, it would be desirable to provide improved systems and methods for providing secured communication between mobile devices, such as SIP tablets, and local networks, such as a marine vessel's internal network, to allow for streamlined and proactive ship inspection programs, while reducing cyber risk.

### SUMMARY

Systems and methods for transferring secure data from one or more external devices to an internal network are provided herein. The systems and methods are particularly useful for allowing secure communication between ship inspection tablets and the ship's internal network.

In one aspect, a docking device for transferring data comprises a housing, a connector for coupling the housing to an external device and a processor comprising a computer-readable storage device and/or a software application storing program instructions. The program instructions, when executed by the processor: authenticate the external device, receive encrypted data from the external device, decrypt the data; re-encrypt the data and transmit the re-encrypted data to an external network.

In embodiments, the external device is mobile device, such as a mobile phone, tablet, smartwatch, mobile computer or the like. In an exemplary embodiment, the external device is an inspection tablet, such as a Ship Inspection Program (SIP) tablet, for collecting data related to a marine vessel. The docking device allows for secured communications between the tablet and the ship's internal network, which reduces cyber risk while allowing for digital real-time inspection and monitoring of the ship.

In embodiments, the docking device further comprises a reader and configured for reading the content from the external device. The reader may, for example, comprise a computer-readable storage device storing program instructions for reading a content from the external device and authenticating the external device based on the content. The program instructions may be further configured to assign a digital token or certificate to the external device to indicate that the external device has been authenticated and, therefore allowed to transmit encrypted data to the device.

In an exemplary embodiment, the reader does not communicate directly with the processor. The reader assigns the digital token or certificate to the external device and the external device transmits the digital token to the processor when it is coupled to the docking device via the connector. Transmitting the digital token through the connector allows the external device to transmit data to the processor. This provides additional data security between the external device and the docking device.

In certain embodiments, the external device includes an authentication device, such as a card, token, pin, USB connector or the like, having a memory for storing the content. The content may include, for example, a barcode, text, image, sound, mechanical projection or depression or other content that is unique to that external device. The content may be stored internal or external to the logic stored in the memory.

In an exemplary embodiment, the authentication device comprises a card such as, for example, a common access card (CAC), smart card or the like. In embodiments, the housing comprises a second connector for receiving the card coupled to the reader.

In embodiments, the external device is configured to require authentication from a user to operate the external device. The authentication may comprise any suitable authentication, such as a personal identification code, password, biometric authentication, token authentication, facial recognition, fingerprint, multi-factor authentication, adaptive authentication or the like. Thus, the user must be authenticated by the external device and the external device must be authenticated by the reader before data may be transmitted to the docking device from the external device.

In embodiments, the docking device comprises a real-time clock disposed within the housing configured to produce one or more clock signals to timestamp data. The clock may include a source of energy, such as battery, and is configured to track time when the device is powered down, thereby allowing the processor devices to obtain updated time to validate tokens or certificates for permission to decrypt messages from the internal network and the external device.

In embodiments, the encrypted data is in a first cipher text, language, code or format and the re-encrypted data is in a second cipher text, language, code or format than the different than the first cipher text language, code or format. For example, the first cipher text or language may be a text or language readable by the external device and the second cipher text or language may be a text or language readable by the internal network. The first and second cipher texts may be encrypted with any suitable cipher system or algorithm, such as AES, data encryption standard (DES), Diffie-Hellman key exchange, elliptical curve cryptography (ECC), quantum key distribution (QKD), RSA, twofish, cipher, pigpen cipher, Caesar cipher, transposition cipher, Caesar shift, Vigenere, Atbash cipher, number, binary, substitution cipher, hash, symmetric, asymmetric or the like.

In embodiments, the data is encrypted by a first encryption key and the program instructions are configured to decrypt the data with a second encryption key. In an exemplary embodiment, the second encryption key is a decryption key. The decryption key may be the same as the first encryption key (i.e., symmetric), or it may be a different key (i.e., asymmetric). The program instructions may be further configured to re-encrypt the data with a third encryption key. In an exemplary embodiment, the third encryption key is different from the first and second encryption keys.

In embodiments, the program instructions are configured to receive a second data encrypted with a fourth encryption key from the external network and decrypt the second data with a fifth encryption key. In an exemplary embodiment, the fifth encryption key is a decryption key. The decryption key may be the same as the fourth encryption key (i.e., symmetric), or it may be a different key (i.e., asymmetric). The program instructions may be further configured to encrypt the second data with a sixth encryption key and transmit the second data to the external device. In an exemplary embodiment, the sixth encryption key is different from the fourth and fifth encryption keys.

In another aspect, a docking device for transferring data comprises a housing, a connector for coupling the housing to an external device and a reader coupled to the connector and configured to read a content on the external device and authenticate the external device based on the content. The docking device further comprises an electronic circuit coupled to the processor and configured to decrypt data received from the external device and re-encrypt the data and a transmitter coupled to the electronic circuit and configured to transmit the re-encrypted data to an external network.

In certain embodiments, the housing is a headless data transfer appliance that does not contain any user interfaces, such as a monitor, keyboard, mouse or the like. In other embodiments, the housing may have one or more user interfaces. The transmitter may comprise any communication interface interconnecting the docking device with an information network, such as a local area network. In an exemplary embodiment, the transmitter is a wireless transmitter, such as an antenna, that transmits data wirelessly, via Bluetooth, WiFi, Zigbee or similar wireless communication protocols.

In embodiments, the processor may comprise any general-purpose computing article of manufacture capable of executing computer program instructions installed thereon, such as a processor, microprocessor, microchip, or application-specific integrated circuit. The processor may comprise at least one communication interface or channel (e.g., a data bus) by which it communicates with the electronic circuit, the reader, the transmitter and other components of the docking device. The processor may include one or more memory devices, such as a local memory, a random-access memory and/or a cache memory.

In embodiments, the reader may comprise any suitable processor, microprocessor, microchip, or application-specific integrated circuit that functions to read data stored in a memory to authenticate that data and protect the device and any external network coupled to the device from unauthorized users. In certain embodiments, the reader comprises a second connector, such as a slot, channel or other opening for receiving a storage device, such as a card, flash drive, disc, solid state drive (SSD) or the like, from the external device.

In embodiments, the encrypted data is in a first cipher text, language, code or format and the re-encrypted data is in a second cipher text, language, code or format different than the first cipher text. In an exemplary embodiment, the second encryption key is a decryption key. The decryption key may be the same as the first encryption key (i.e., symmetric), or it may be a different key (i.e., asymmetric). The program instructions may be further configured to re-encrypt the data with a third encryption key. In an exemplary embodiment, the third encryption key is different from the first and second encryption keys.

In embodiments, the external device further comprises a card having a memory for storing the content. The content may include, for example, a bar text, text, image, sound, mechanical projection or depression or other content that is unique to that external device. The content may be stored internal or external to the logic stored in the memory. In an exemplary embodiment, the card may be, for example, a common access card (CAC). The housing comprises a second connector coupled to the reader for receiving the card.

In embodiments, the docking device further comprises a receiver for receiving a second data from the external network. The electronic circuit is coupled to the receiver and configured to decrypt the second data. The electronic circuit is configured to re-encrypt the second data and transmit the second data to the external device. In one embodiment, the electronic circuit is configured to receive a second data encrypted with a third private key from the external network and decrypt the second data with a fourth private key.

In embodiments, the connector comprises a universal serial bus and the external device comprises a mobile device comprising a connector for coupling to the universal serial bus. In an exemplary embodiment, the mobile device comprises an inspection tablet, such as a Ship Inspection Program (SIP) tablet, for collecting data related to a marine vessel.

In another aspect, a method for receiving data comprises coupling an external device to a docking device, transmitting encrypted data from the external device to the docking device and decrypting the data with the docking device. The data is then re-encrypted with the docking device and transmitted to an external network. In embodiments, the re-encrypted data is in a first text and the encrypted data is in a second text different than the first text.

In embodiments, the method further comprises authenticating the external device with the docking device. The device may assign a token or digital certificate indicating that the external device has been authenticated. In an exemplary embodiment, a card comprising a memory storing a content is inserted into the docking device to authenticate the external device

In embodiments, the method comprises encrypting the data with a first encryption key and decrypting the data with a second encryption key. The encrypted data is in a first cipher text, language, code or format and the re-encrypted data is in a second cipher text, language, code or format different than the first cipher text, language, code or format. In an exemplary embodiment, the second encryption key is a decryption key. The decryption key may be the same as the first encryption key (i.e., symmetric), or it may be a different key (i.e., asymmetric). The program instructions may be further configured to re-encrypt the data with a third encryption key. In an exemplary embodiment, the third encryption key is different from the first and second encryption keys.

In embodiments, the method further comprises receiving a second data from the external network, decrypting the second data, re-encrypting the second data and transmitting the second data to the external device. In an exemplary embodiment, the second data is decrypted with a decryption key. The decryption key may be the same as the key used to re-encrypt the data, or it may be a different key.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1A is a perspective view of a data transfer device;

FIG. 1B is a front view of the data transfer device of FIG. 1A;

FIG. 1C is a rear view of the data transfer device of FIG. 1A;

FIG. 2 is an exploded view of the data transfer device;

FIG. 3 schematically illustrates certain components of the data transfer device;

FIG. 4 schematically illustrates the data transfer device connected to an external device, such as an inspection tablet;

FIG. 5 is a circuit diagram of a real time clock for the data transfer device;

FIG. 6 is a circuit diagram of an LED control circuit for the data transfer device;

FIG. 7 is a process diagram for the data transfer device;

FIG. 8 is a flow diagram for the data transfer device; and

FIG. 9 is another flow diagram for the data transfer device.

### DESCRIPTION OF THE EMBODIMENTS

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Systems and methods for transferring secure data from one or more external devices to an internal network are provided herein. The systems and methods are particularly useful for allowing secured communication between ship inspection program (SIP) tablets and a SAMM database via the ship's internal network.

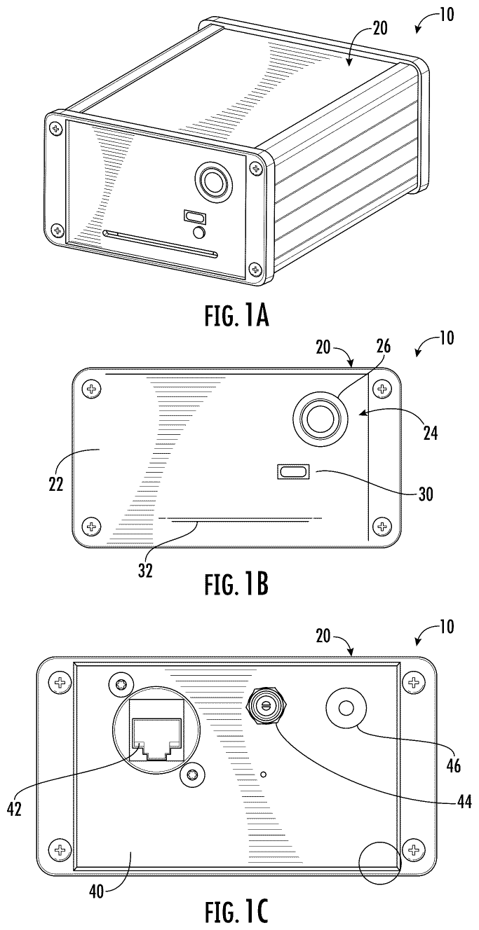

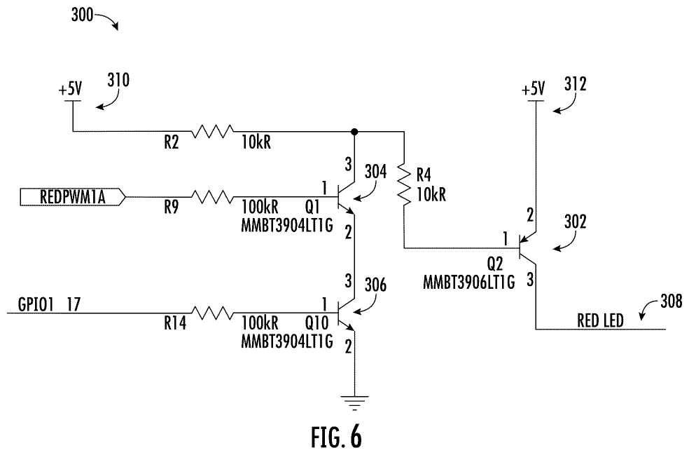

Referring now to FIGS. 1A-1C, a data transfer device 10 comprises a housing 20, which may comprise any suitable material for protecting electronic components, such as a clear extruded anodized aluminum. While housing 20 is illustrated as a substantially rectangular prism, it is contemplated that housing 20 may have any suitable shape, such as cubical, spherical, cylindrical and the like. Housing 20 generally comprises a front plate 22 having a power button 24 and a status indicator 26 for indicating to the user when the power is ON or OFF. Status indicator 26 may be coupled to an electronic circuit 300 within housing 20 (discussed below in referenced to FIG. 6). In an exemplary embodiment, status indicator 26 provides an annular light (e.g., blue) that indicates that the power button 24 has been switched ON. Front plate 22 further includes a connector 30 for electrically connecting data transfer device 10 to an external device, such as a tablet or the like. Connector 30 may comprise, for example, a universal serial bus or USB-C connector. Front plate 22 further includes a slot 32 or other type of opening for receiving a user authentication device, such as a common access card (CAC). Housing 20 comprises a back plate 40 having a connector 42, such as an ethernet connector, for coupling housing 20 to an external network. Back plate 40 further includes an input-power connector 44 and an audio-jack serial port 46. The power supply may be any suitable external power supply. In an exemplary embodiment, the power supply comprises a 5 Volt (+/−0.25 Volts) input power with a capacity of 2 Amps of current, such as a GEFEN 5 Volts, 4.0 Amp EXT-PS54AULPN-6.

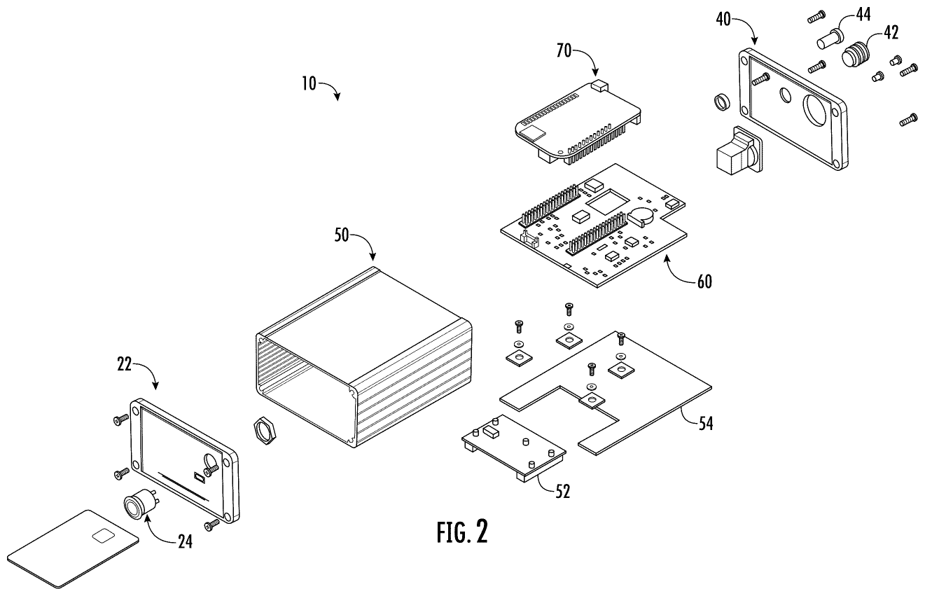

Referring to FIG. 2, housing 20 preferably comprises an extruded case 50 having a plurality of internal slots for housing the electronic components of device 10. The electronic components include a reader 52 secured within case 50 by a plate 54 comprising a rigid material, such as aluminum or the like. Reader 52 and plate 54 rest on one of the internal slots towards the bottom of case 50 such that reader 52 is substantially aligned with slot 32. Reader 52 may comprise any suitable processor, microprocessor, microchip, or application-specific integrated circuit that functions to read data stored in a memory to authenticate that data and protect device 10 and any external network coupled to device 10 from unauthorized users. The content may include, for example, a bar text, text, image, sound, mechanical projection or depression or other content that is unique to that external device. The content may be stored internal or external to the logic stored in the memory.

In certain embodiments, the external device includes an authentication device, such as a card, token, pin, USB connector or the like, having a memory for storing the content. The content may include, for example, a barcode, text, image, sound, mechanical projection or depression or other content that is unique to that external device. The content may be stored internal or external to the logic stored in the memory. In an exemplary embodiment, the authentication device comprises a card such as, for example, a common access card (CAC), smart card or the like. I

In an exemplary embodiment, reader 52 functions to read data from a common access card (not shown) that may be inserted into slot 32. Reader 52 may be further configured to assign a token or other digital certificate to the common access card to indicate to device 10 that the specific external device associated with the card is authenticated and may transfer data or messages to device 10. In one embodiment, reader 52 comprises a processor and a computer-readable storage device or software application storing that includes program instructions for reading a content from the external device and authenticating the external device based on the content. The program instructions may be further configured to assign a digital token or certificate to the external device to indicate that the external device has been authenticated and is allowed to transmit encrypted data to the device. In an exemplary embodiment, reader 52 comprises an Omnikey 3121 circuit board manufactured by HID Global.

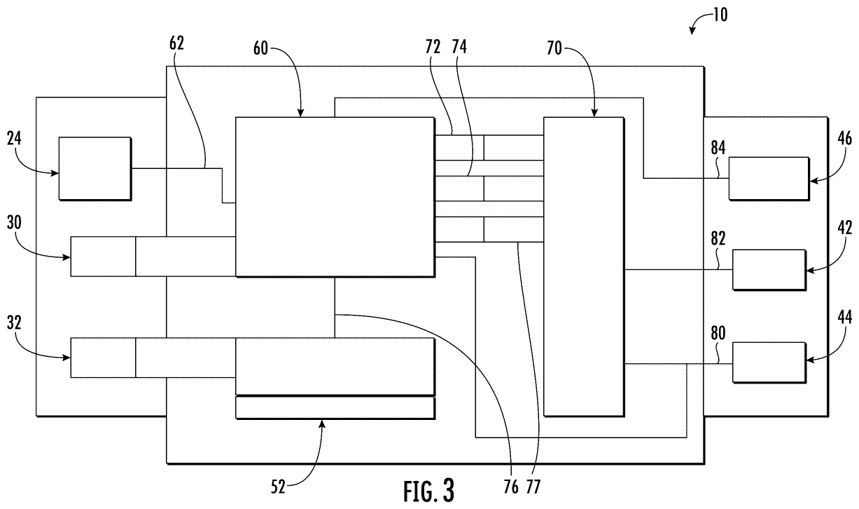

The electronic components further include a first computing device 60 and a second computing device 70 connected to the first computing device 60 via, for example 46-pin headers 72, 74 and a 6 pin header 77 (See FIG. 3). First and second computing devices 60, 70 may comprise any general-purpose computing article of manufacture capable of executing computer program instructions installed thereon. Computing devices 60, 70 can include one or more processors (e.g., microprocessor, microchip, or application-specific integrated circuit), one or more memory devices (e.g., random-access memory and/or read-only memory), and a communication interface. The memory devices can include a local memory (e.g., a random-access memory and a cache memory) employed during execution of program instructions. However, the computing devices 60, 70 are only representative of various possible computing devices that can perform the processes described herein. To this extent, in embodiments, the functionality provided by the computing devices 60, 70 can be any combination of general and/or specific purpose hardware and/or computer program instructions. In each embodiment, the program instructions and hardware can be created using standard programming and engineering techniques.

In certain embodiments, computing device 60 comprises a processor that provides an interface between second computing device 70, a power supply and other electronics (discussed below). The power supply may comprise an external power supply, an internal power supply or both. In certain embodiments, the power supply comprises an internal battery that functions as a backup when external power is not available (discussed below).

In an exemplary embodiment, reader 52 does not communicate directly with computing devices 60, 70. Reader 52 assigns the digital token or certificate to the external device and the external device transmits the digital token to computing device 60 when it is coupled to docking device 10 via the connector 62. Transmitting the digital token through the connector 62 allows the external device to transmit data to computing device 60. This provides additional data security between the external device and the docking device.

Second computing device 70 functions to decrypt data, such as a proprietary network request or message, from an external device, such as a tablet or the like. Second computing device 70 includes a processor and a computer-readable storage device storing program instructions that, when executed by the processor, converts the encrypted data into a data that is readable by computing devices 60, 70. In certain embodiments, computing device converts cyphertext to plaintext data. Computing device 70 may use any suitable decryption method, such as symmetric decryption, asymmetric decryption, hashing, pigpen cipher, Caesar cipher, transposition cipher, Caesar shift, Vigenere, Atbash cipher, number, binary, substitution cipher, data encryption standard (DES), AES, data encryption standard (DES), Diffie-Hellman key exchange, elliptical curve cryptography (ECC), quantum key distribution (QKD), RSA, twofish, or the like. In certain embodiments, computing device is configured to input a decryption key into the data to decrypt the data.

In an exemplary embodiment, the data is encrypted by a first encryption key and the program instructions in computing device 70 are configured to decrypt the data with a second encryption key. In an exemplary embodiment, the second encryption key is a decryption key. The decryption key may be the same as the first encryption key (i.e., symmetric), or it may be a different key (i.e., asymmetric). The program instructions may be further configured to re-encrypt the data with a third encryption key. In an exemplary embodiment, the third encryption key is different from the first and second encryption keys.

Device 70 further functions to re-encrypt the request or message to a standard network encryption text that will be transmitted to the external network (discussed in more detail below). In embodiments, the encrypted data is in a first cipher text, language or format and the re-encrypted data is in a second cipher text, language, code or format different than the first cipher text, language, code or format. For example, the first cipher text, language, code or format may be readable by the external device and the second cipher text, language, code or format may be readable by the internal network. Device 70 may use any suitable encryption method, such as symmetric decryption, asymmetric decryption, hashing, pigpen cipher, Caesar cipher, transposition cipher, Caesar shift, Vigenere, Atbash cipher, number, binary, substitution cipher, data encryption standard (DES), AES, data encryption standard (DES), Diffie-Hellman key exchange, elliptical curve cryptography (ECC), quantum key distribution (QKD), RSA, twofish, or the like. In an exemplary embodiment, the data may be encrypted by computing device 70.

In embodiments, the program instructions are configured to receive a second data encrypted with a fourth encryption key from the external network and decrypt the second data with a fifth encryption key. In an exemplary embodiment, the fifth encryption key is a decryption key. The decryption key may be the same as the fourth encryption key (i.e., symmetric), or it may be a different key (i.e., asymmetric). The program instructions may be further configured to encrypt the second data with a sixth encryption key and transmit the second data to the external device. In an exemplary embodiment, the sixth encryption key is different from the fourth and fifth encryption keys.

In certain embodiments, the encrypted data from the external device has a first cipher text and the re-encrypted data has a second cipher text. The first cipher text is different than the second cipher text to enhance security of the data transmission.

In certain embodiments, first computing device 60 is a processor that resides on second computing device 70. First and second computing devices 60, 70 may comprise any suitable processing or circuit board, such as the BeagleBone Black board that includes an ARM Cortex-A8-based processor manufactured by Texas Instruments. The processor 60 may comprise a chipset, such as the Sitara AM3358, and may include a NEO floating point accelerator and quantity two 32 bit 200 MHz programmable real-time units (PRUs). This hardware provides access to various functions (discussed below) via ADC, 12C, SPI and PWM.

System 10 may further comprise one or more software programs or applications that provide functionality to operate computing devices 60 and 70. In an exemplary embodiment, the software programs comprise a modified version of Debian version 12 Linux OS.

FIG. 3 schematically illustrates the electronic components of device 10. As shown, first computing device 60 is coupled to power switch 24 and USB connector 30 by a suitable electronic connector 62, such as a 6-pin power cable or the like. Computing device 60 may be further coupled to reader 52 by any suitable electronic connector 76, such as a 5 pin cable or the like, to transfer power to reader 52 (although reader 52 preferably does not communicate or otherwise transfer data to computing device 60). Computing device 60 is further coupled to computing device 70 via 46 pin connectors 72, 74 and a 6 pin connector 77 and to audio-jack serial port 46 via a 3-wire serial cable 84 (or similar connector). Computing device 70 is coupled to input-power connector 44 via a power and filter cable 80 and to ethernet connector 42 via any suitable ethernet cable 82.

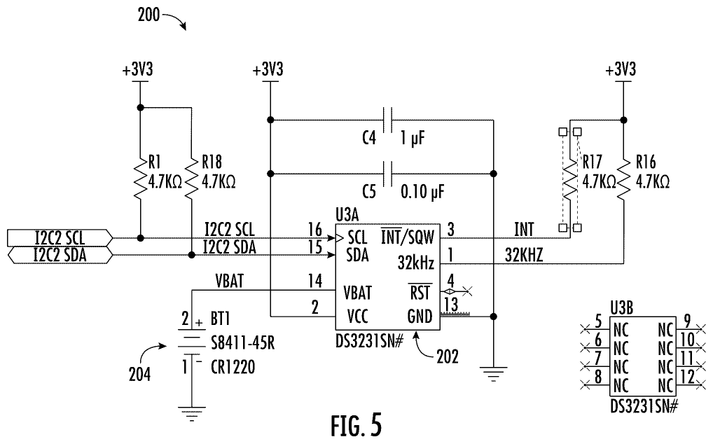

Device 10 may further include a real-time clock 200 (see FIG. 5) comprising a battery backed integrated circuit 202 that tracks time when powered down. This allows computing devices 60, 70 to timestamp data related to authenticated devices and to validate tokens or certificates provided to such authenticated devices for permission to decrypt messages. Real-time clock 200 is configured to track seconds, minutes, hours and days. In an exemplary embodiment, clock 200 is an analog device that works over 12 C and employs a lithium-ion battery 204 with form factor CR 1220 and outputs 3.0 volts.

In an exemplary embodiment, the battery life of real-time clock 200 is about at least about 1 year, or at least about 2 years or at least about 5 years, or at least about 10 years (at 40 mAh (CR1220 Capacity)/0.84 uA (nominal timekeeping mode), provided that the device is connected to external power during that period of time.

As described above, device 10 may further include a status indicator 26, such as an LED ring, or the like, that interacts with the user with status LEDs to alert to the status of device 10. Computing device 60 preferably comprises a circuit 300 (see FIG. 6) comprising one or more transistors 302, 304, 306 that control one or more light emitting devices (LEDs) 308 with low current control and to gain access to the electrical power to provide brightness that bypasses computing device 60. A voltage may be applied across two inputs 310, 312 to drive transistors 302, 304, 306. This inhibits the processor from heating up as LEDs are driven.

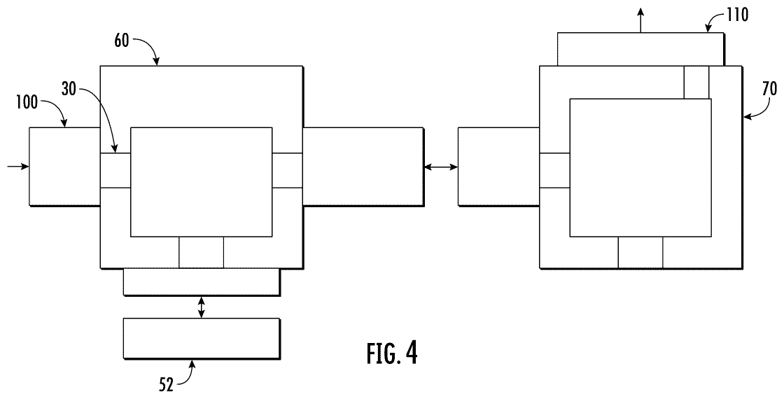

Referring now to FIG. 4, the external device 100 is coupled to computing device 60 via USB connector 30. External device 100 may comprise any suitable mobile device, such as a mobile phone, tablet, smartwatch, mobile computer or the like. In embodiments, the external device 100 is configured to require authentication from a user to operate the external device. The authentication may comprise any suitable authentication, such as a personal identification code, password, biometric authentication, token authentication, facial recognition, fingerprint, multi-factor authentication, adaptive authentication or the like.

In an exemplary embodiment, device 100 comprises an inspection tablet, such as a ship inspection program (SIP) tablet, that includes a uniform inspection protocol for collecting data related to a vessel's structural condition, operating systems, equipment, certificates and documents, navigation safety, emergency systems, crew procedural compliance and/or other critical functions of a marine vessel. In an exemplary embodiment, the inspection protocol comprises a Ship Inspection Report Programme (SIRE) for inspecting the parameters of maritime vessels, such as oil tankers, chemical tankers, gas carriers, military vessels and the like, based on a standardized set of questions and requirements known as the SIRE Vessel Inspection Questionnaire (VIQ). External device 10 is configured to upload questions to an internal network on the vessel based on numerous inspection reports specific for that particular vessel. Device 100 may be configured, for example, to send data requests to device 10 based on the inspection reports.

As shown, computing device 70 is coupled to a private external network 110 via ethernet connector 42 (or through another suitable connector, or wirelessly). In an exemplary embodiment, the external network 110 comprises a local network on a maritime vessel that includes a database comprising a variety of different parameters related to the current status of various components of the vessel.

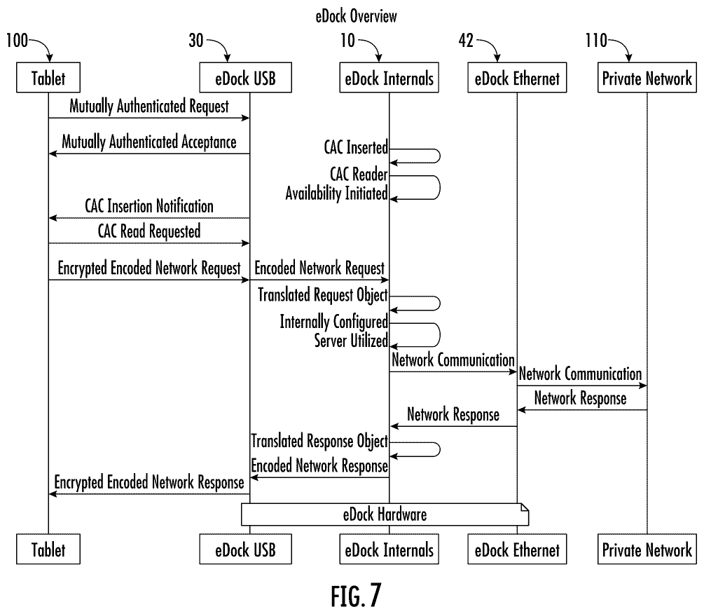

FIG. 7 schematically illustrates use of docking device 10 to transfer data from external device 100 to private network 110. As shown, external device 100 is coupled to device 10 via USB connector 30 and device 10 responds by accepting the request to authenticate. The user may then insert a CAC card into slot 32 of housing 20. Reader 52 reads the memory on the card, authenticates device 100 and transmits a signal, such as a token or other digital certificate, indicating that device 100 has been accepted. External device 100 may then transmit an encrypted network request to device 10.

Once the encrypted network request or message is received by computing devices 60, 70, it is decrypted by device 70. Device 70 then re-encrypts the request or message into a different text that may be decrypted by internal network 110. Device transmits the re-encrypted message to internal network via ethernet connector 42.

Internal network 110 will be configured to decrypt the message from device 70 and transmit an encrypted response to the request or message to device 10. Computing devices 60, 70 then repeat the process of decrypting the response from internal network 110, re-encrypting the response into a different text, and transmitting the re-encrypted response to external device 100. This ensures that all communications between external table 100 and internal network 110 remain secure.

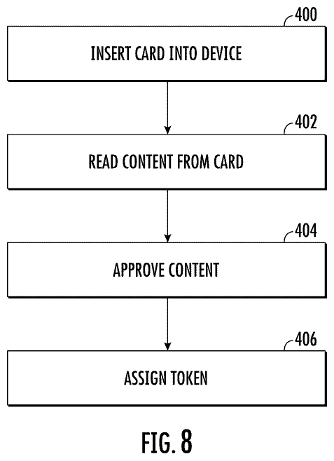

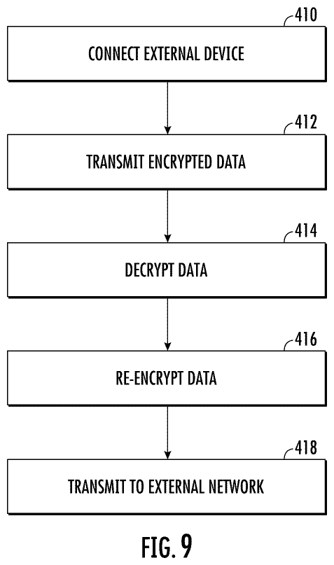

FIGS. 8 and 9 illustrate a method of transmitting secured data between an external device 100 and an internal network 110. In a first step 400, the user inserts a CAC card into device 100. In a second and third step 402, 403 reader 52 reads the memory from the CAC card and approves the content. In a fourth step, reader 52 assigns a token or other digital certificate to device 100.

As shown in FIG. 9, external device 100 is connected to device 10 (step 410) and an encrypted message or other data is transmitted to device 100 (step 412). Device 10 decrypts the data into plaintext or another computer language readable by computing devices 60, 70 (step 414). Device 10 then re-encrypts the data into a text that is readable by the external network 110 (step 416). Finally, device 10 transmit the re-encrypted data to network 110 (step 418).

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, in a first aspect, a first embodiment is a device for transferring data. The device comprises a housing, a connector for coupling the housing to an external device and a processor comprising a computer-readable storage device storing program instructions that, when executed by the processor, the program instructions; authenticate the external device; receive data encrypted from the external device; decrypt the data; re-encrypt the data; and transmit the data to an external network.

A second embodiment is the first embodiment, wherein the encrypted data is in a first cipher text and the re-encrypted data is in a second cipher text, wherein the first cipher text is different than the second cipher text.

A third embodiment is any combination of the first 2 embodiments, wherein the program instructions are configured to read a content from the external device and authenticate the external device based on the content.

A 4^{th} embodiment is any combination of the first 3 embodiments, wherein the program instructions are configured to assign a digital token to the external device to indicate authentication of said external device.

A 5^{th} embodiment is any combination of the first 4 embodiments, wherein the data is encrypted by a first key and the program instructions decrypt the data with a second key.

A 6^{th} embodiment is any combination of the first 5 embodiments, wherein the program instructions re-encrypt the data with a third key.

A 7^{th} embodiment is any combination of the first 6 embodiments, wherein the program instructions: receive a second data encrypted with a fourth key from the external network; and decrypt the second data with a fifth key.

An 8^{th} embodiment is any combination of the first 7 embodiments, wherein the program instructions: encrypt the second data with a sixth key and transmit the second data to the external device.

A 9^{th} embodiment is any combination of the first 8 embodiments, further comprising a reader coupled to the processer and configured for reading the content from the external device.

A 10^{th} embodiment is any combination of the first 9 embodiments, further comprising a card having a memory for storing the content.

An 11^{th} embodiment is any combination of the first 10 embodiments, wherein the housing comprises a second connector for receiving the card, the second connector coupled to the reader.

A 12^{th} embodiment is any combination of the first 11 embodiments, further comprising a real-time clock disposed within the housing for measuring passage of time.

A 13^{th} embodiment is any combination of the first 12 embodiments, further comprising a source of energy coupled to the real-time clock.

A 14^{th} embodiment is any combination of the first 13 embodiments, wherein the external device comprises a mobile device.

A 15^{th} embodiment is any combination of the first 14 embodiments, wherein the mobile device comprises an inspection tablet for a marine vessel.

In another aspect, a first embodiment is a device for transferring data comprising. The device comprises a housing, a connector for coupling the housing to an external device, a reader coupled to the connector and configured to read a content on the external device, a processor coupled to the reader and configured to authenticate the external device based on the content and a transmitter coupled to the processor and configured to transmit the re-encrypted data to an external network. The processor is configured to decrypt data received from the external device and re-encrypt the data for transmission to the external network.

A second embodiment is the first embodiment, wherein the data is encrypted in a first cipher text and the processor re-encrypts data into a second cipher text, wherein the first cipher text is different than the second cipher text.

A third embodiment is any combination of the first 2 embodiments, further comprising a card having a memory for storing the content.

A 4^{th} embodiment is any combination of the first 3 embodiments, wherein the housing comprises a second connector for receiving the card, the second connector coupled to the reader.

A 5^{th} embodiment is any combination of the first 4 embodiments, wherein the reader is configured to assign a digital token to the external device.

A 6^{th} embodiment is any combination of the first 5 embodiments, further comprising a receiver for receiving a second data from the external network.

A 7^{th} embodiment is any combination of the first 6 embodiments, wherein the processor is coupled to the receiver and configured to decrypt the second data.

An 8^{th} embodiment is any combination of the first 7 embodiments, wherein the processor is configured to re-encrypt the second data and transmit the second data to the external device.

A 9^{th} embodiment is any combination of the first 8 embodiments, wherein the data is encrypted by a first key and the processor decrypts the data with a second key.

A 10^{th} embodiment is any combination of the first 9 embodiments, wherein the processor is configured to re-encrypt the data with a third key.

An 11^{th} embodiment is any combination of the first 10 embodiments, wherein the processor is configured to receive a second data encrypted with a fourth key from the external network and decrypt the second data with a fifth key.

A 12^{th} embodiment is any combination of the first 11 embodiments, wherein the connector comprises a universal serial bus.

A 13^{th} embodiment is any combination of the first 12 embodiments, wherein the external device comprises a mobile device comprising a connector for coupling to the universal serial bus.

A 14^{th} embodiment is any combination of the first 13 embodiments, wherein the mobile device comprises an inspection tablet for a marine vessel.

In another aspect, a method for receiving data comprises coupling an external device to a docking device, transmitting encrypted data from the external device to the docking device, decrypting the data with the docking device, re-encrypting the data with the docking device and transmitting the data to an external network.

A second embodiment is the first embodiment, wherein the data is transmitted to the docking device with a first cipher text and transmitted to the external device with a second cipher text, wherein the first cipher text is different than the second cipher text.

A third embodiment is any combination of the first 2 embodiments, further comprising authenticating the external device with the docking device.

A 4^{th} embodiment is any combination of the first 3 embodiments, further comprising encrypting the data with a first key and decrypting the data with a second key.

A 5^{th} embodiment is any combination of the first 4 embodiments, further comprising re-encrypting the data with a third key.

A 6^{th} embodiment is any combination of the first 5 embodiments, further comprising: receiving a second data from the external network; decrypting the second data; re-encrypting the second data; and transmitting the second data to the external device.

A 7^{th} embodiment is any combination of the first 6 embodiments, wherein the second data is transmitted to the docking device with a first cipher text and transmitted to the external device with a second cipher text, wherein the first cipher text is different than the second cipher text.

An 8^{th} embodiment is any combination of the first 7 embodiments, further comprising inserting a card comprising a memory storing a content into the docking device to authenticate the external device.

A 9^{th} embodiment is any combination of the first 8 embodiments, wherein the external device comprises an inspection tablet for a marine vessel.

1. A device for transferring data, the device comprising:
a housing;
a connector for coupling the housing to an external device;
a processor comprising a computer-readable storage device storing program instructions that, when executed by the processor, the program instructions;
authenticate the external device;
receive data encrypted from the external device;
decrypt the data;
re-encrypt the data; and
transmit the data to an external network.

2. The device of claim 1, wherein the encrypted data is in a first cipher text and the re-encrypted data is in a second cipher text, wherein the first cipher text is different than the second cipher text.

3. The device of claim 1, wherein the program instructions are configured to read a content from the external device and authenticate the external device based on the content.

4. The device of claim 3, wherein the program instructions are configured to assign a digital token to the external device to indicate authentication of said external device.

5. The device of claim 1, wherein the data is encrypted by a first key and the program instructions decrypt the data with a second key.

6. The device of claim 5, wherein the program instructions re-encrypt the data with a third key.

7. The device of claim 6, wherein the program instructions:
receive a second data encrypted with a fourth key from the external network;
decrypt the second data with a fifth key.

8. The device of claim 1, wherein the program instructions:
encrypt the second data with a sixth key; and
transmit the second data to the external device.

9. The device of claim 1, further comprising a reader coupled to the processer and configured for reading the content from the external device.

10. The device of claim 9, further comprising a card having a memory for storing the content, wherein the housing comprises a second connector for receiving the card, the second connector coupled to the reader.

11. The device of claim 1, further comprising a real-time clock disposed within the housing for measuring passage of time, further comprising a source of energy coupled to the real-time clock.

12. The device of claim 1, wherein the external device comprises a mobile device, wherein the mobile device comprises an inspection tablet for a marine vessel.

13. A method for receiving data, the method comprising:
coupling an external device to a docking device;
transmitting encrypted data from the external device to the docking device;
decrypting the data with the docking device;
re-encrypting the data with the docking device; and
transmitting the data to an external network.

14. The method of claim 13, wherein the data is transmitted to the docking device with a first cipher text and transmitted to the external device with a second cipher text, wherein the first cipher text is different than the second cipher text.

15. The method of claim 13, further comprising authenticating the external device with the docking device.

16. The method of claim 13, further comprising encrypting the data with a first key and decrypting the data with a second key.

17. The device of claim 16, further comprising re-encrypting the data with a third key.

18. The method of claim 17, further comprising:
receiving a second data from the external network;
decrypting the second data;
re-encrypting the second data; and
transmitting the second data to the external device.

19. The method of claim 18, wherein the second data is transmitted to the docking device with a first cipher text and transmitted to the external device with a second cipher text, wherein the first cipher text is different than the second cipher text.

20. The method of claim 19, further comprising inserting a card comprising a memory storing a content into the docking device to authenticate the external device.
